(19) United States
(12) Patent Application Publication
(10) Pub. No.: US 2005/0239918 A1
(43) Pub. Date: Oct. 27, 2005

(54) Novel polymer compound, composition containing the compound, ink composition, ink-applying method, and ink-applying apparatus

(75) Inventors: Ikuo Nakazawa, Zama-shi (JP); Koichi Sato, Atsugi-shi (JP); Ryuji Higashi, Atsugi-shi (JP); Sakae Suda, Sagamihara-shi (JP); Keiichiro Tsubaki, Kawasaki-shi (JP); Keiko Yamagishi, Ebina-shi (JP); Masayuki Ikegami, Atsugi-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/102,764

(22) Filed: Apr. 11, 2005

(30) Foreign Application Priority Data
Apr. 12, 2004 (JP) 2004-116802 (PAT.
May 7, 2004 (JP) 2004-139052 (PAT.

(51) Int. Cl. C03C 17/00; C09D 11/00

(52) U.S. Cl. 523/160; 523/161

(57) ABSTRACT

A block copolymer comprises three block segments of a first segment, a second segment, and a third segment, and containing a polyalkenyl ether main chain, wherein the first segment is hydrophilic or hydrophobic, the second segment is hydrophobic, and the third segment is ionic; and at least one of the block segments has a structure represented by General Formula (1) below:
—(CRaRb-CRc(OR¹))— (1)
wherein Ra, Rb, and Rc are respectively H or CH₃; R¹ is selected from the group consisting of linear, branched, or cyclic alkyl groups of 1 to 18 carbon atoms, —(CH(R²)—CH(R³)—O)ₗ—R⁴, and —(CH₂)ₘ—(O)ₙ—R⁴; l and m are an integer from 1 to 12; n is 0 or 1; R² and R³ are H or CH₃; R₄ is selected from the group consisting of H, linear, branched or cyclic alkyl groups of 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR⁵, -PhCOOR⁵, —CH₂SO₃R⁵, and -PhSO₃R⁵; the hydrogen on the carbon atoms constituting R⁴ except R⁵ moiety may be replaced by a linear or branched alkyl group of 1 to 4 carbon atoms, and the carbon in the aromatic ring may be replaced by nitrogen; and R⁵ is H, an alkyl group of 1 to 5 carbon atoms, or mono- or higher-valent cation.

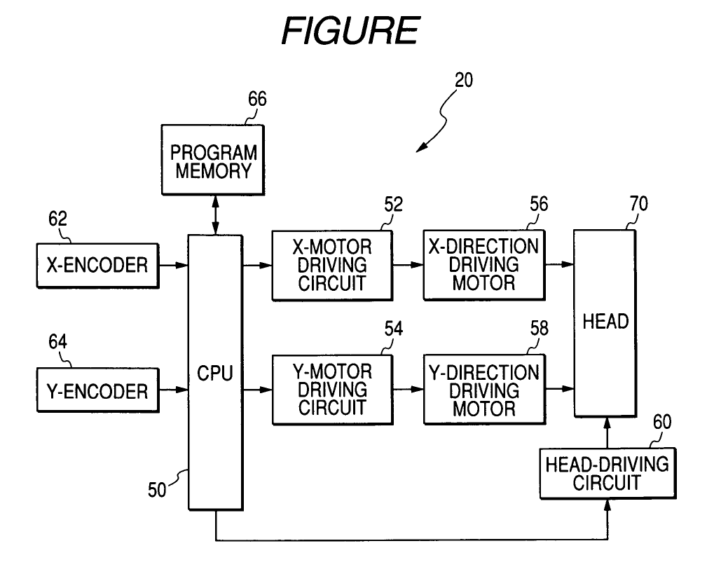

### BACKGROUND OF THE INVENTION

1. Field of the Invention

The present invention relates to a novel polymer compound, a composition containing the polymer compound, an ink composition, an ink-applying method, and an ink-applying apparatus.

2. Related Background Art

Compositions containing particulate solid are known as functional materials, including pesticides such as herbicides, and insecticides; medicines such as anticancer agents, antialergy agents; toners and inks containing functional material as a colorant. Recently, digital printing techniques are progressing remarkably. A typical example is an inkjet technique. The inkjet technique is becoming more and more important as image-forming technique.

The inkjet method, which is a direct recording method, has advantages of compactness and low power consumption of the apparatus. In an inkjet system, the ink supplied from an ink tank is heated in a nozzle by a heater to be ejected by bubbling and evaporation onto a recording medium to form an image. In another inkjet system, an ink is ejected from a nozzle by vibration of a piezo element. With the development of such techniques, the quality of the image formed by a digital printing system has become comparable to that of a silver salt photograph. However, for substitution of the silver salt photograph or conventional printed matter, the digital color print should have weather resistance as well as the high image quality. For the higher weather resistance, use of a pigment dispersion ink (U.S. Pat. No. 5,085,698), film lamination, and the like techniques are being investigated, but many problems are left to be improved.

For dispersion of a pigment, use of a polymer, such as polymer having a sulfonic group is disclosed (U.S. Pat. No. 5,713,993). This method still has problems to be solved. Further, an ink composition is disclosed which is an aqueous dispersion containing an ABC type tri-block copolymer as a dispersant (U.S. Pat. No. 5,519,085). This method fixes an ink composition by permeation into a paper sheet, so that a higher fixation speed is necessary for increase of the printing speed.

### SUMMARY OF THE INVENTION

The present invention has been made on the above technical background.

The present invention provides a block copolymer which enables sufficient dispersion of a functional substance in a solvent.

The present invention provides also an ink composition which comprises preferably a colorant as the functional substance and water as the solvent, and in which the colorant is dispersed satisfactorily.

The present invention provides further an ink composition in which the colorant has high dispersion stability in the solvent, and which is improved in the ink fixation property.

The present invention further provides a liquid-applying method employing the above functional substance composition, and a liquid-applying apparatus for conducting the liquid-applying method.

According to an aspect of the present invention, there is provided a block copolymer comprising three block segments of a first segment, a second segment, and a third segment, and containing a polyalkenyl ether main chain, wherein
the first segment is hydrophilic or hydrophobic,
the second segment is hydrophobic, and
the third segment is ionic; and
at least one of the block segments has a structure represented by General Formula (1) below:
   —(CRaRb-CRc(OR¹))— (1)
   wherein Ra, Rb, and Rc are respectively H or CH₃; R¹ is selected from the group consisting of linear, branched, or cyclic alkyl groups of 1 to 18 carbon atoms, —(CH(R²)—CH(R³)—O)ₗ—R⁴, and —(CH₂)ₘ—(O)ₙ—R⁴; l and m are an integer from 1 to 12; n is 0 or 1; R and R³ are H or CH₃; R₄ is selected from the group consisting of H, linear, branched or cyclic alkyl groups of 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR⁵, -PhCOOR⁵, —CH₂SO₃R⁵, and -PhSO₃R⁵; the hydrogen on the carbon atoms constituting R⁴ except R⁵ moiety may be replaced by a linear or branched alkyl group of 1 to 4 carbon atoms, and the carbon in the aromatic ring may be replaced by nitrogen; and R⁵ is H, an alkyl group of 1 to 5 carbon atoms, or mono- or higher-valent cation. The third segment preferably has at least one residue derived from at least one chemical species selected from the group consisting of carboxylic acids, carboxylic acid salts, sulfonic acids, sulfonic acid salts.

According to another aspect of the present invention, there is provided a composition comprising the block copolymer, a functional substance, and a solvent. The solvent is preferably an aqueous solvent.

Alternatively, the functional substance is preferably a colorant, and the composition is preferably used as an ink. The solvent is preferably an aqueous solvent.

The composition is preferably used as an ink for inkjet printing.

According to a further aspect of the present invention, there is provided a method for applying an ink comprising the steps of providing the composition used as an ink, and applying the composition on a medium.

According to a still further aspect of the present invention, there is provided an ink applying apparatus, comprising an ink applying means for applying the composition used as an ink, onto a medium by giving an energy to the composition, and a driving means for driving the ink applying means.

According to the present invention, the ink composition is improved in dispersion of the colorant in the solvent, and in fixability of the colorant. Further according to the present invention an excellent image forming method and an excellent image forming apparatus is provided by use of the above composition in which the colorant has high dispersibility.

### BRIEF DESCRIPTION OF THE DRAWING

FIGURE is a schematic diagram showing outline of an image recording apparatus applicable to the present invention.

### DETAILED DESCRIPTION OF THE PREFERRED EMBODIMENTS

A composition is desirably capable of changing its state or property for stages of its use. The composition of the present invention has a feature that the state or property thereof is changeable in correspondence with external stimulation (hereinafter referred to as “stimulation-responsiveness”). For example, in use for an ink, the composition of the present invention can be designed such that the viscosity increases in response to external stimulation after printing on a recording medium like a paper sheet in the process of image formation to prevent ink running and to increase the fixation rate for high fixability of the colorant. The utilization of stimulation for ink fixation in the present invention is a feature different from the disclosure of the above-mentioned U.S. Pat. No. 5,519,085 which utilizes only penetration of an ink into a paper sheet. The stimulation to be applied to the composition of the present invention includes addition of a chemical substance like a cation; temperature change; exposure to an electromagnetic wave like ultraviolet light, visible light, or infrared light; pH change of the composition; and concentration change. The change of the state in correspondence with stimulation is exemplified by a phase change from a sol state to a gel state, a phase change from a solution state to a solid state, and change in the chemical structure. The response to stimulation in the present invention is described below more specifically.

The chemical substance like a cation to be added for the stimulation is exemplified by multivalent ionic metals. When a multivalent cationic metal is added to a composition containing a polymer constituted of repeating unit having an anionic substituent such as a carboxylic acid residue or a sulfonic acid residue, it produces an electric attraction force to increase the viscosity of the composition to realize excellent fixability.

The temperature change for the stimulation ranges across the phase transition temperature of the composition.

The wavelength of the electromagnetic wave for exposure of the composition as the stimulation ranges preferably from 100 to 800 nm.

The pH change for the stimulation of the composition ranges preferably from pH 3 to pH 12.

The change of the concentration of the composition for the stimulation can be caused by evaporation or absorption of a solvent of the composition to change a polymer concentration. The concentration change ranges preferably across the concentration causing the phase transition.

Two or more kinds of the stimulation may be applied in combination.

The present invention has another feature of improvement of scratch resistance. As described later in detail, the block copolymer constituting the composition of the present invention has a micelle-formation property, being capable preferably of enclosing a colorant in the micelle in the ink. The enclosed colorant applied onto a recording medium is not directly rubbed even when it is rubbed with a line marker or a like thing, decreasing running of the colorant. In this point, this feature of the present invention is different from the disclosure of the above mentioned U.S. Pat. No. 5,519,085.

In the composition of the present invention, the ionic segment (hereinafter referred to as a “C-segment”) has preferably at least one residual group derived from at least one chemical species selected from carboxylic acids, carboxylic acid salts, sulfonic acids, sulfonic acid salts.

More preferably, at least one of the three block segments have a group represented by Formula (1) having a vinyl ether structure in which Ra, Rb, or Rc is H. Still more preferably, at least one of the segments of the block copolymer is responsive to stimulation. Still more preferably, the block copolymer has a number-average molecular weight ranging from 8,000 to 1,000,000, and the ABC-tri-block copolymer has a molecular weight distribution of not broader than 1.8. The block copolymer has a glass transition temperature of not higher than 20° C.

The ionic segment in the present invention is protected, before the polymerization, by a suitable protecting group such as an ester group, and after the polymerization the protecting group is eliminated. When the elimination by hydrolysis of the protecting group is conducted by an alkali, the polymer of the present invention is desirably resistant to the alkali since the polymer is kept in an alkaline medium.

In using a composition of the present invention in which the solvent is an aqueous solvent, the block copolymer may be dispersed in the aqueous solvent by dissociation of the C-segment. One method therefor is to make the solvent alkaline. In this method, the composition of the present invention should be resistant to alkali. This method is also an embodiment of the present invention.

In use of the ink composition for inkjet printing (hereinafter referred to simply as an “inkjet ink”) of the present invention in a thermal type of inkjet printing system, the ink composition is heated to a high temperature, so that the ink composition of the present invention is preferably resistant to the high temperature in the alkaline environment.

A conventional acrylic acid type polymer is liable to be hydrolyzed at the ester linkage site in an alkaline state, especially at a high temperature conditions. In contrast, the polymer of the present invention having a polyalkenyl structure defining the polymer can be improved in resistance in an alkali state in comparison with the ester type polymer, since the polyalkenyl structure can be modified by introducing a functional group to the main chain and the modifying functional group is linked to the main chain by an ether linkage.

Many processes are disclosed on the synthesis of polymers of a polyalkenyl ether structure (e.g., Japanese Patent application Laid-Open No. H11-080221). Of these processes, typical is a cationic living polymerization process disclosed by Aoshima (Japanese Patent Application Laid-Open Nos. H11-322942, and H11-322866). By the cationic living polymerization, various polymers can be synthesized, including homopolymers, copolymers constituted of two or more monomers, block copolymers, graft copolymers, and gradient copolymers with precise uniform chain length and molecular weight.

The cationic polymerization of the polymer of the polyalkenyl structure can also be conducted by an HI/I₂ system, an HCl/SnCl₄ system, and the like system.

In the present invention, the linear or branched alkyl group includes methyl, ethyl, n-propyl, isopropyl, n-butyl, s-butyl, t-butyl, pentyl, n-hexyl, heptyl, octyl, nonyl, decyl, undecyl, dodecyl, and octadecyl. The cyclic alkyl group includes cyclopropyl, cyclobutyl, cyclopentyl, cyclohexyl, and cyclooctyl. The substitution of the hydrogen on the carbon atom may be conducted on one carbon atom or plural carbon atoms.

The inkjet ink of the present invention has stimulation-responsiveness preferably owing to the responsiveness of at least one segment of the block copolymer constituting the ink. The repeating unit of the block segment has preferably a vinyl ether structure having a substituent of Formula (1) in which Ra, Rb, and Rc are respectively H. More preferably, the block copolymer has a number-average molecular weight ranging from 8000 to 1,000,000, a molecular weight distribution of not broader than 1.8, and a glass transition temperature of not higher than 20° C. The vinyl ether polymers represented by General Formula (2) below are preferred.
—(CH₂—CH(OR⁶))— (2)
In the above formula, R⁶ is selected from the group consisting of a linear, branched, or cyclic alkyl of 1-18 carbon atoms, and -Ph, -Pyr, -Ph-Ph, -Ph-Pyr, —(CH₂—CH₂O)ₗ—R⁷, and —(CH₂)ₘ—(O)ₙ—R⁷, and a hydrogen on the aromatic ring may be substituted by a linear or branched alkyl of 1-4 carbon atoms, and a carbon atoms in the aromatic ring may be substituted by a nitrogen atom; l is an integer of 1-18; m is an integer of 1-36; and n is 0 or 1. R⁷ is selected from the group consisting of H, a linear, branched, or cyclic alkyl of 1-18 carbon atoms, and -Ph, -Pyr, -Ph-Ph, -Ph-Pyr, —CHO, —CH₂CHO, —CO—CH═CH₂, —CO—C(CH₃)═CH₂, —CH₂COOR⁸, -PhCOOR⁸, —CH₂SO₃R⁸, and -PhSO₃R⁸. A hydrogen on a carbon atom constituting R⁷ may be substituted by a linear or branched alkyl of 1-4 carbon atoms, or F, Cl, or Br; a carbon of an aromatic ring may be substituted by nitrogen, and a hydrogen on an aromatic ring may be substituted by F, Cl, or Br. R⁸ is H, alkyl of 1-5 carbon atoms, or a cation. Of the repeating unit of Formula (1), particularly preferred monomer units are shown by the structural formulas (I-a) to (I-q).

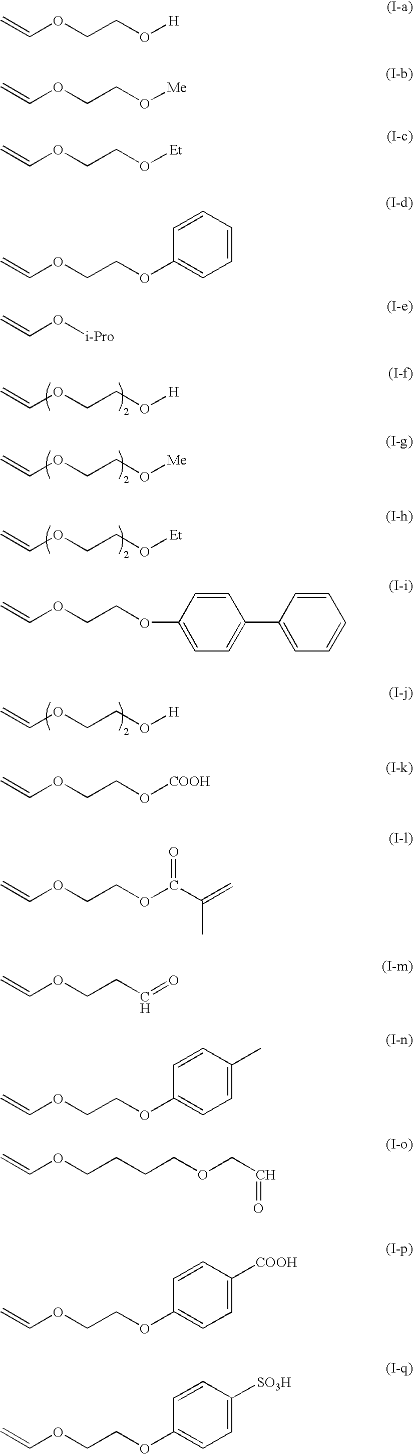

Among the above monomers I-a to I-q, the monomers I-a, I-f, I-h, and I-j can constitute a hydrophilic segment of the polymer; I-d, I-e, I-i, I-l, I-m, I-n, and I-o can constitute a hydrophilic segment (hereinafter referred to as a “B-segment”) of the polymer. The monomers I-b, I-c, and I-g can constitute a stimulation-responsive polymer segment which is changeable by thermal stimulation from hydrophilic to hydrophobic or from hydrophobic to hydrophilic. The monomers I-k, I-p, and I-q can constitute a C-segment which is changeable by stimulation by pH or an ion from hydrophilic to hydrophobic or from hydrophobic to hydrophilic. The monomers I-a, I-j, I-k, I-p, I-q, etc. containing a hydroxyl group, a carboxylic acid structure, or a sulfonic acid structure need to be protected in polymerization, and are protected by alkyl silyl (e.g., t-butyldimethylsilyl), alkyl (e.g., ethyl ester), or the like.

Each of the block segments may be constituted of a copolymer of an alkenyl ether type monomer and another type monomer.

The first block segment which may be either a hydrophilic segment or a hydrophobic segment is referred to as an “A-segment” in the present invention.

The ratio of the A-segment, the B-segment, and the C-segment contained in the block copolymer having the polyalkenyl ether structure in the present invention is preferably 5 to 95 mol % of the A-segment, 5 to 95 mol % of the B-segment, and 2 to 95 mol % of C-segment, the segments totaling 100%. A stimulation-responsive segment may be employed arbitrarily. For example, when the monomer unit I-c is employed, each segment is heat-responsive to be controllable to be hydrophilic or hydrophobic by the temperature: hydrophilic at a temperature lower than 20° C. and hydrophobic at a temperature higher than 20° C.

These block copolymers containing polyalkenyl ether structure constituted of any of these alkenyl ether monomers are useful in the present invention. The polymers useful in the present invention include those having the polyalkenyl ether structure having stimulation-responsiveness constituted of the above alkenyl ether monomer, but are not limited thereto. Examples thereof are shown below without limiting the polymer of the present invention thereto. 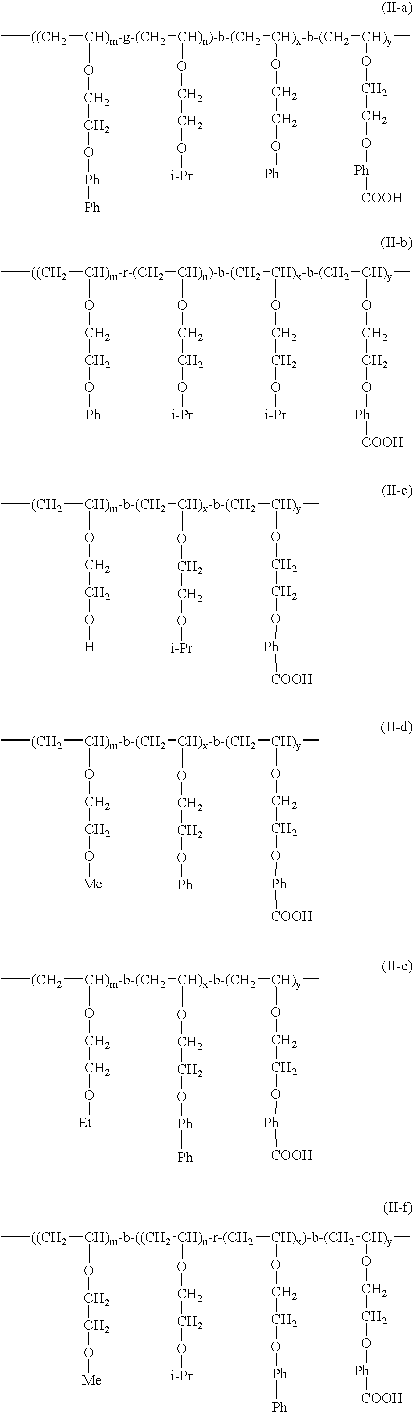 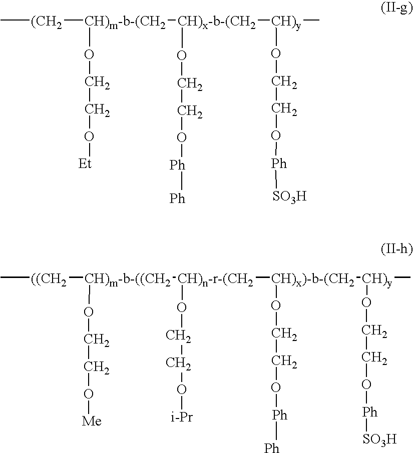
In the above structural formulas, the symbols b, g, and r represent respectively a linking type: block, gradient, and random.

The numbers of the repeating units of the polyalkenyl ether, namely x, y, m, and n, are independently in the range of preferably from 1 to 10,000 in Formulas (II-a) to (II-b), and the total (x+y+m+n) is in the range of preferably from 30 to 40,000 in Formulas (II-a) to (II-e). When the B-segment and the C-segment are independently constituted of two or more kinds of monomers, each of the segments may be a random polymer or a gradient polymer.

The number-average molecular weight of the tri-block copolymer ranges preferably from 5,000 to 1,000,000, more preferably from 8,000 to 500,000. A lower molecular weight of tri-block copolymer lowers stimulation responsiveness or lowers the intended functionality, whereas a higher molecular weight lowers solubleness of the tri-block copolymer in a solvent, undesirably in practical use. The present invention is different in the preferred molecular weight from description of the above mentioned U.S. Pat. No. 5,519,085 in which the typical molecular weight ranges from 1000 to 7500.

The molecular weight distribution of the tri-block copolymer is preferably narrower for showing stimulation-responsiveness of the tri-block copolymer. Generally the molecular weight distribution is not broader than 1.8, preferably not broader than 1.6, more preferably not broader than 1.3, still more preferably not broader than 1.2.

The tri-block copolymer having a lower glass transition temperature has a more flexible molecular structure and is more affinitive to a colorant. Therefore, at least one segment of the tri-block copolymer has a glass transition temperature of not higher than 20° C., preferably not higher than 0° C., more preferably not higher than −20° C. In this point, use of the polymer having the alkenyl ether structure is desirable.

The present invention covers a functional substance composition comprising the aforementioned tri-block copolymer, a functional substance, and a solvent.

The block copolymer is contained in the ink composition of the present invention at a content ranging from 0.1 to 50 wt %, preferably from 0.5 to 30 wt %. At a content of lower than 0.1 wt % of the block copolymer, the colorant in the ink composition of the present invention tends to be less dispersible, whereas at a content of the block copolymer of higher than 50 wt %, the ink composition tends to be excessively viscous.

A preferred embodiment of the present invention is a functional substance dispersion composition in which a substance and a block copolymer are dispersed in a state of particles in a solvent, but the present invention is not limited thereto.

(Water)

The water contained in the inkjet ink of the present invention is preferably deionized water made free from metal ions and like ions, pure water, or ultrapure water.

(Aqueous Solvent)

The aqueous solvent includes polyhydric alcohols such as ethylene glycol, diethylene glycol, triethylene glycol, polyethylene glycol, propylene glycol, and glycerin; polyhydric alcohol ethers such as ethylene glycol monomethyl ether, ethylene glycol monoethyl ether, ethylene glycol monobutyl ether, diethylene glycol monoethyl ether, and diethylene glycol monobutyl ether; nitrogen-containing solvents such as N-methyl-1-pyrrolidone, substituted pyrrolidones, and triethanolamine. Further, for acceleration of drying of the inkjet ink on a recording medium, a monohydric alcohol such as methanol, ethanol, and isopropanol may be used.

The content of the water and aqueous solvent mentioned above in the inkjet ink ranges preferably from 20 to 95 wt %, more preferably from 30 to 95 wt % based on the entire weight of the ink.

(Colorant)

The colorant in the present invention is a substance capable of coloring a material or used for coloring a material. Therefore, the colorant includes not only substances which give the color thereof to another material but also materials which give color by reaction with another substance

The colorant itself useful in the present invention may be in a state of a liquid, or a solid, or may be a solution of a solid dye in a solvent.

The pigment as the colorant may be an organic pigment or an inorganic pigment. The pigment useful for the ink includes black pigments, and primary color pigments of cyan pigments, magenta pigments, yellow pigments, red pigments, green pigments, and blue pigments. Incidentally, a color pigment not mentioned above, or a colorless or pale color pigment, or a metallic luster pigment may be used. Otherwise, a novel pigment may be synthesized and used for the present invention. The pigment used has an average primary particle size of 50 nm. A commercial pigment may be used, or a pigment may be pulverized by milling or mechanical crushing, and classified for the use.

Examples of commercial pigments of black, cyan, magenta, and yellow are shown below.

The black color pigments include Raven 1060, Raven 1080, Raven 1170, Raven 1200, Raven 1250, Raven 1255, Raven 1500, Raven 2000, Raven 3500, Raven 5250, Raven 5750, Raven 7000, Raven 5000 ULTRAII, Raven 1190 ULTRAII (Columbia Carbon Co.); Black Pearls L.MOGUL-L.Regal 400R, Regal 660R, Regal 330R, Monark 800, Monark 880, Monark 900, Monark 1000, Monark 1300, Monark 1400 (Cabot Co.); Color Black FW1, Color Black FW2, Color Black FW200, Color Black 18, color Black S160, Color Black S170, Special Black 4, Special Black 4A, Special Black 6, Printex 35, Printex 140U, Printex V, Printex 140V (Deggussa Co.); No. 25, No. 33, No. 40, No. 47, No. 52, No. 900, No. 2300, MCF-88, MA600, MA7, MA8, MA100 (Mitsubishi Chemical Co.), and so forth, but are not limited thereto.

The cyan color pigments include C.I.Pigment Blue-1, C.I.Pigment Blue-2, C.I.Pigment Blue-3, C.I.Pigment Blue-15, C.I.Pigment Blue-15:2, C.I.Pigment Blue-15:3, C.I.Pigment Blue-15:4, C.I.Pigment Blue-16, C.I.Pigment Blue-22, C.I.Pigment Blue-60, and so forth, but are not limited thereto.

The magenta color pigments include C.I.Pigment Red-5, C.I.Pigment Red-7, C.I.Pigment Red-12, C.I.Pigment Red-48, C.I.Pigment Red-48:1, C.I.Pigment Red-57, C.I.Pigment Red-112, C.I.Pigment Red-122, C.I.Pigment Red-123, C.I.Pigment Red-146, C.I.Pigment Red-168, C.I.Pigment Red-184, C.I.Pigment Red-202, C.I.Pigment Red-207, and so forth, but are not limited thereto.

The yellow color pigments include C.I.Pigment Yellow-12, C.I.Pigment Yellow-13, C.I.Pigment Yellow-14, C.I.Pigment Yellow-16, C.I.Pigment Yellow-17, C.I.Pigment Yellow-74, C.I.Pigment Yellow-83, C.I.Pigment Yellow-93, C.I.Pigment Yellow-95, C.I.Pigment Yellow-97, C.I.Pigment Yellow-98, C.I.Pigment Yellow-114, C.I.Pigment Yellow-128, C.I.Pigment Yellow-129, C.I.Pigment Yellow-151, C.I.Pigment Yellow 154, and so forth, but are not limited thereto.

The pigment is used in the ink composition of the present invention at a content ranging from 0.1 to 50 wt % based on the weight of the ink. At the pigment content of less than 0.1 wt %, a sufficient image concentration is not obtained, whereas at the pigment content of higher than 50 wt %, the image fixation can be insufficient. The content preferred ranges from 0.5 to 30 wt %.

In the case where a dye is used as a solution in a solvent, water-soluble dyes and oil-soluble dye are suitably used. The colorant used in the ink composition of the present invention is contained at a concentration ranging from 0.1 to 50 wt % based on the weight of the aqueous composition. The dye useful for the inkjet ink of the present invention may be a known dye, and includes direct dyes, acid dyes, basic dyes, reactive dyes, and water-soluble dyes

and oil-soluble dyes for foodstuffs.

Specific examples of dyes for the inkjet ink of the present invention are shown below.

The water-soluble dyes include:

direct dyes such as

C.I.Direct Black-17, -19, -22, -32, -38, -51, -62, -71, -108, -146, and -154;
C.I.Direct Yellow-12, -24, -26, -44, -86, -87, -98, -100, -130, and -142;
C.I.Direct Red-1, -4, -13, -17, -23, -28, -31, -62, -79, -81, -83, -89, -227, -240, -242, and -243;
C.I.Direct Blue-6, -22-, -25, -71, -78, -86, -90, -106, and -199;
C.I.Direct Orange-34, -39, -44, -46, and -60;
C.I.Direct Violet-47, and -48;
C.I.Direct Brown-109; and
C.I.Direct Green-59;
   acid dyes such as
C.I.Acid Black-2, -7, -24, -26, -31, -52, -63, -112, -118, -168, -172, and -208;
C.I.Acid Yellow-11, -17, -23, -25, -29, -42, -49, -61, and -71;
C.I.Acid Red-1, -6, -8, -32, -37, -51, -52, -80, -85, -87, -92, -94, -115, -180, -254, -256, -289, -315, and -317;
C.I.Acid Blue-9, -22, -40, -59, -93, -102, -104, -113, -117, -120, -167, -229, -234, and -254;
C.I.Acid Orange-7, and -19; and C.I.Acid Violet-49;
   reactive dyes such as
C.I.Reactive Black-1, -5, -8, -13, -14, -23, -31, -34, and -39;
C.I.Reactive Yellow-2, -3, -13, -15, -17, -18, -23, -24, -37, -42, -57, -58, -64, -75, -76, -77, -79, -81, -84, -85, -87, -88, -91, -92, -93, -95, -102, -111, -115, -116, -130, -131, -132, -133, -135, -137, -139, -140, -142, -143, -144, -145, -146, -147, -148, -151, -162, and -163;
C.I.Reactive Red-3, -13, -16, -21, -22, -23, -24, -29, -31, -33, -35, -45, -49, -55, -63, -85, -106, -109, -111, -112, -113, -114, -118, -126, -128, -130, -131, -141, -151, -170, -171, -174, -176, -177, -183, -184, -186, -187, -188, -190, -193, -194, -195, -196, -200, -201, -202, -204, -206, -218, and -221;
C.I.Reactive Blue-2, -3, -5, -8, -10, -13, -14, -15, -18, -19, -21, -25, -27, -28, -38, -39, -40, -41, -49, -52, -63, -71, -72, -74, -75, -77, -78, -89, -100, -101, -104, -105, -119, -122, -147, -158, -160, -162, -166, -169, -170, -171, -172, -173, -174, -176, -179, -184, -190, -191, -194, -195, -198, -204, -211, -216, and -217;
C.I.Reactive Orange-5, -7, -11, -12, -13, -15, -16, -35, -45, -46, -56, -62, -70, -72, -74, -82, -84, -87, -91, -92, -93, -95, -97, and -99;
C.I.Reactive Violet-1, -4, -5, -6, -22, -24, -33, -36, and -38;
C.I.Reactive Green-5, -8, -12, -15, -19, and -23; and
C.I.Reactive Brown-2, -7, -8, -9, -11, -16, -17, -18, -21, -24, -26, -31, -32, and -33;
   basic dyes such as
C.I.Basic Black-2;
C.I.Basic Red-1, -2, -9, -12, -13, -14, and -27;
C.I.Basic Blue-1, -3, -5, -7, -9, -24, -25, -26, -28, and -29;
C.I.Basic Violet-7, -14, and -27; and
C.I.Food Black-1, and -2;
   and so forth.

The fat-soluble dyes include Oil orange 201, Oil Orange PR, Oil Brown BB, Oil Brown OR, Oil Brown 416, Oil Green 502, VALIFAST GREEN 1501, VARIFAST GREEN 2520, Oil Yellow 129, Oil Yellow GGS, Oil Black 860, Oil Black BS, Oil Black HBB, Oil Black BY, and so forth.

The above liquid colorants are particularly suitable for the inkjet ink of the present invention. However, the liquid colorant for the inkjet ink of the present invention is not limited thereto.

The liquid colorant for use for the inkjet ink of the present invention is used at a concentration ranging preferably from 0.1 to 50 wt % based on the weight of the ink. At the concentration lower than 0.1 wt %, the density of the obtained image is not sufficient, whereas at the concentration higher than 50 wt %, the fixability of the formed image tends to be lower. More preferably the concentration ranges from 0.5 to 30 wt %.

(Additive)

To the inkjet ink of the present invention, various additives and auxiliary agents may be added as necessary.

An example of the additive is a dispersion stabilizer for dispersing stably polymer micelles in the solvent. In the inkjet ink of the present invention, the polyalkenyl ether structure serves to stabilize the dispersion of the micelles. However, if the dispersion stabilization is not sufficient, an additional dispersion stabilizer may be added.

The additional dispersion stabilizer includes resins having both a hydrophilic portion and a hydrophobic portion, and surfactants.

The resin having a hydrophilic portion and a hydrophobic portion is exemplified by copolymers of a hydrophilic monomer and a hydrophobic monomer. The hydrophilic monomer includes acrylic acid, methacrylic acid, maleic acid, fumaric acid, and monoesters of the above carboxylic acids, vinyl sulfonic acid, styrenesulfonic acid, vinyl alcohol, acrylamide, methacryloxyethyl phosphate, and so forth. The hydrophobic monomer includes styrene; styrene derivatives such as α-methylstyrene; vinylcyclohexane; vinylnaphthalene derivatives; acrylic acid esters; methacrylic acid esters; and so forth. The copolymer may be of any type, including random copolymers, block copolymers, and graft copolymers. Naturally the hydrophilic monomers and the hydrophobic monomers are not limited to the above-mentioned ones.

The surfactant includes anionic surfactants, nonionic surfactants, cationic surfactants, and ampholytic surfactants.

The anionic surfactant includes fatty acid salts, alkylsulfate ester salts, alkylarylsulfonate salts, alkyldiaryl ether disulfonate salts, dialkylsulfosuccinate salts, alkylphosphate salts, naphthalenesulfonic acid-formalin condensates, polyoxyethylene alkylphosphate ester salts, and glycerol borate fatty acid esters.

The nonionic surfactant includes polyoxyehtylene alkyl ethers, polyoxyethylene oxypropylene block copolymers, sorbitan fatty acid esters, glycerin fatty acid esters, polyoxyethylene fatty acid esters, polyoxyethylenealkylamines, fluorine type surfactants, and silicone type surfactants.

The cationic surfactant includes, alkylamine salts, quaternary ammonium salts, alkylpyridinium salts, and alkylimidazolium salts.

The ampholytic surfactant includes alkylbetaines, alkylamine oxides, and phosphatidylcholine. The surfactants are not limited to the above examples.

Further, an aqueous solvent may be added, as necessary, to the inkjet ink of the present invention. In inkjet printing, the aqueous solvent serves to prevent drying and solidification of the ink at the nozzle, and may be used singly or in combination of two or more thereof. The kinds of the aqueous solvents are mentioned before. The amount of addition to the ink ranges from 0.1 to 60 wt %, preferably from 1 to 25 wt % based on the total weight of the ink.

The additive further includes pH adjusting agents for stabilization of the inkjet ink and stabilization of tubing of the inkjet ink in a recording apparatus; penetrants for promoting penetration of the ink into a recording medium to accelerate apparent drying; fungicides for preventing growth of fungi in an ink; chelating agents for chelating metal ions in an ink to prevent deposition of a metal or insoluble matter at a nozzle; antifoaming agents to prevent foaming in circulation and transfer of the ink or production of the ink; antioxidants; viscosity-adjusting agents; conductant agents; UV absorbing agents; water-soluble dyes; dispersion dyes; and oil-soluble dyes.

The inkjet ink (aqueous dispersion ink) as a preferred embodiment of the present invention is described below more specifically.

(Production of Inkjet Ink)

In a preferred embodiment of the production of the ink employing a colorant and a tri-block copolymer, firstly a colorant is dispersed or dissolved in a solvent, then the solution is added to an aqueous solution containing the tri-block copolymer dispersed or dissolved therein, and the organic solvent is removed to obtain a dispersion. However, the production process is not limited thereto.

In another method for dispersion, the tri-block copolymer may be dispersed by means of a dispersing means such as an ultrasonic homogenizer, a laboratory homogenizer, a colloid mill, a jet mill, and ball mill, and combination thereof.

The colorant may be suitably enclosed in the tri-block copolymer of the ink composition. The hydrophobic segments of the polymer of the present invention will gather together to form particles and the hydrophilic segments surrounds the particles by solvation to form aggregates in the absence of a functional substance like a colorant to be enclosed.

The amphiphilic block copolymer will gather together spontaneously in a solution in various types: in micelles, cylinders, lamellas, or the like depending on the ratio of the hydrophilic segments and hydrophobic segments, the concentration, or other conditions of the amphiphilic polymer. The enclosure in the present invention is caused by the micelle formation of the amphiphilic block copolymer. In an example employing water as the solvent, the hydrophobic segments gather together to form aggregate particles and the hydrophilic segments cover the particles to form dispersion in the water. In the micelle formation, a hydrophobic substance such as a water-insoluble dye and a hydrophobic polymer will be enclosed in the micelles. The micelle formation is confirmed as spherical micelles by observation of the ink composition by EF-TEM by cryotransfer. The enclosure can be confirmed by elemental analysis of this sample by EELS. The enclosure state can also be confirmed by utilizing the stimulation-response of the ink composition. This is explained by taking the aforementioned ABC tri-block copolymer (II-d) as the amphiphilic block copolymer, and a pigment as the colorant. The C-segment of the ABC tri-block copolymer (II-d) ionizes in an alkaline medium, whereas the A-segment thereof becomes hydrophilic by stimulation-responsiveness in an acidic medium at a temperature of 20° C. or lower. In other words, in an acidic environment at 20° C. or higher, all of the segments of the ABC tri-block copolymer (II-d) become hydrophobic and incapable of forming the micelles to deposit in the aqueous solvent. Consequently, the pigment and the hydrophobic polymer are brought into direct contact with the solvent without enclosure in the micelles, and are allowed to separate and precipitate from the aqueous solvent owing to lack of the dispersibility or solubility, whereby the aqueous phase is entirely decolored. From the above result, the enclosure in the amphiphilic block copolymer is confirmed.

In the Examples described later, the ink composition employs an aqueous solvent as the solvent and a pigment as the functional substance, and the tri-block copolymer forms micelles to enclose the colorant. This point is a feature of the present invention, being different from the invention of U.S. Pat. No. 5,519,085.

(Image-Forming Method and Image-Forming Apparatus)

The ink of the present invention is useful in various image-forming systems of printing, inkjet recording, electrophotography, and the like, images can be formed with the apparatus.

In the present invention, various types of inkjet recording apparatus are useful as the inkjet printer employing the inkjet ink, including piezo inkjet systems which employ a piezo element, and thermal inkjet systems which conduct recording by bubbling of the ink by action of thermal energy.

In the apparatus of the present invention, for example, the amount of ink ejected from ejection outlet of an ejection head ranges from 0.1 to 100 pL for improved image resolution.

In particular, the inkjet recording apparatus as an embodiment of the recording apparatus of the present invention comprises a means for contacting the inkjet ink with a composition containing a crosslinking additive (crosslinking agent) for crosslinking the block copolymer by changing a solvent environment as stimulation. In this embodiment, the inkjet ink is fixed by the contact on the recording medium to form excellent image.

The inkjet ink of the present invention can be used in an indirect recording apparatus in which image is formed on an intermediate transfer medium, and then the image is transferred onto recording medium such as paper sheet. The apparatus can be used in an apparatus in which direct recording is conducted on an intermediate transfer medium.

In particular, the inkjet ink of the present invention is useful in image forming methods and image-forming apparatuses of electrophotographic recording system. In an example, the image-forming apparatus comprises a photosensitive drum for latent image formation, a latent image-forming means (e.g., light-projecting means), an ink-applying means, an image transfer mechanism, and a recording medium. With this apparatus, for image formation, a latent image on the photosensitive drum, the inkjet ink of the present invention is applied onto the portion of the latent image or the portion other than the latent image, the obtained image is transferred to a recording medium by a transfer mechanism, and the transfer image is fixed.

The inkjet recording apparatus is explained roughly by reference to FIGURE. FIGURE shows only an example without limiting the invention.

FIGURE is a block diagram showing a constitution of an inkjet recording apparatus for recording on a recording medium by moving a head. In FIGURE, CPU 50 controls the entire of the recording apparatus. To CPU 50, are connected X-direction driving motor 56 and Y-direction driving motor 58 for driving head 70 in XY directions with interposition of X-motor driving circuit 52 and Y-motor driving circuit 54. X-direction motor 56 and Y-direction motor 58 are driven in accordance with the instruction given by the CPU through X-motor circuit 52 and Y-motor driving circuit 54, whereby the head 70 is brought to a prescribed position of the recording medium.

As shown in FIGURE, head-driving circuit 60 is connected to head 70. CPU 50 controls head-driving circuit 60 to drive head 70 to eject the inkjet ink. Further, X-encorder 62 and Y-encorder are connected to CPU 50 to detect the position of head 70, whereby the information on the position of head 70 is inputted to CPU 50. A control program is inputted to program memory 66. CPU 50 moves head 70 according to a control program and the information on the position from X-encorder 62 and Y-encorder 64 to an intended position of the recording medium and to eject the inkjet ink. In such a manner, an intended image can be formed on the recording medium. A recording apparatus which can use plural kinds of inkjet inks forms an intended image on the recording medium by repeating the above operation prescribed times.

After ejection of the inkjet ink, head 70 is moved to the position of a cleaning means (not shown in the diagram) to wipe head 70 for removal of an excess ink adhering to the head. The cleaning operation can be conducted by a conventional method.

After the image recording, the recording medium is replaced with a fresh one by a recording medium delivery mechanism not shown in the diagram.

The present invention may be modified or changed within the gist thereof. In the above explanation, head 70 is moved in XY axis directions. Instead, head 70 may be moved in an X direction (or Y direction) only, and the recording medium may be moved in a Y direction (or X direction) for image formation in connection of the movement of the head and the recording medium.

In the present invention, a heat energy-generating means (e.g., an electrothermal transducer, a laser light, etc.) is provided as the source of energy for ejection of the inkjet ink. The heat energy enables efficient ejection of the inkjet ink. With such a system, the image can be formed with high fineness. The use of the inkjet ink of the present invention improves further the image quality.

The basic and typical constitution and principle of the apparatus equipped with a thermal energy-generating means are disclosed in U.S. Pat. Nos. 4,723,129 and 4,740,796. These systems can be applied to on-demand types and continuous types. In particular, with an on-demand type apparatus, at least one driving signal is applied to an electrothermal transducer placed in a liquid flow channel holding the liquid in correspondence with ejection information to cause abrupt temperature rise above the nuclear boiling temperature to form a bubble in the liquid in one-to-one correspondence with the driving signal. The liquid is ejected by the growth and contraction of the bubble to form at least one liquid droplet. By applying the driving signal in a pulse wave shape, the bubble grows and contracts instantaneously appropriately to cause ejection of the liquid with high responsiveness preferably. Suitable driving signals in a pulse shape are disclosed in U.S. Pat. Nos. 4,463,359, and 4,345,262. More effective ejection can be conducted by the conditions disclosed in U.S. Pat. No. 4,313,124 regarding the temperature elevation rate of the heating face.

The head, in the above patent disclosures, has a constitution of combination of an ejection outlet, a liquid flow channel, and an electrothermal transducer (a linear flow channel or a rectangular flow channel). The present invention includes other constitutions, disclosed in U.S. Pat. Nos. 4,558,333 and 4,459,600 in which the thermal action site is placed at a bend portion. Further, the present invention can be practiced effectively by the constitution having a common slit as ejection portion on plural electrothermal transducer disclosed in Japanese Patent Application Laid-Open No. S59-123670, or by the constitution having an open hole for absorbing pressure wave of the thermal energy in opposition to the ejection portion disclosed in Japanese Patent Laid-Open No. S59-138461. Thus the present invention enables precise and efficient ejection of the inkjet ink regardless of the shape of the head.

The image-forming apparatus of the present invention is applicable effectively to a full-line type heads having a breadth corresponding to the maximum breadth of the recording medium. This type of head may be constituted of a combination of plural heads to cover the full length, or may be constituted of one integrated head.

The image-forming apparatus of the present invention is also applicable to serial type heads which are fixed to the main body of the apparatus, or which are of an exchangeable chip type mounted on the main body of the apparatus and connected electrically to the main body or capable of receiving ink from the apparatus main body.

The apparatus of the present invention may further be provided with a liquid droplet-removing means. Such a means achieves further an excellent ejection effect.

To the constitution of the apparatus of the present invention, an additional auxiliary means may be supplemented. The additional means can stabilize preferably the effects of the present invention. The additional auxiliary means includes a capping means for capping the head, a pressurizing or sucking means, an electrothermal converter or another type heating element, a preliminary heating means employing a combination of the above heating means, and a supplemental ejection means different from the ejection for image formation.

The present invention is most effectively applied to the film-boiling type systems mentioned above.

### EXAMPLES

The present invention is explained below in detail by reference to Examples without limiting the present invention. Examples below explain a method of synthesis of the tri-block copolymer of the present invention, and an inkjet ink employing a disperse dye as an example of the inkjet ink. Examples show synthesis of the polymer and the disperse dye ink specifically without limiting the present invention.

### Example 1

Synthesis of Tri-Block Copolymer Constituted of A-Segment: Methoxyethyl Alkenyl Ether (MOVE), B-Segment: Random Copolymer of Isobutyl Alkenyl Ether and CH₂═CHOCH₂CH₂OPhPh (IBVE-r-BPhOVE), C-Segment: 4-(2-Vinyloxy)ethoxybenzoic Acid (HBVE) (Poly[MOVE-b-(IBVE-r-BPhOVE)-b-HBVE] (II-f) (“b” denotes a block copolymer, “r” denotes a random copolymer)

A glass container having a three-way stopcock was purged with nitrogen, and was heated in a nitrogen atmosphere to 250° C. to eliminate adsorbed water. The system was brought to room temperature. Thereto, were added 20 mmol of MOVE, 16 mmol of ethyl acetate, 0.1 mmol of 1-isobutoxyethyl acetate, and 11 mL of toluene. The reaction system was cooled to 0° C. Thereto 0.2 mmol of ethylaluminum sesquichloride (an equimolar mixture of diethylaluminum chloride and ethylaluminum dichloride) was added to initiate polymerization. The molecular weight of the growing polymer was monitored at prescribed intervals by molecular sieve column chromatography (GPC) and NMR to detect the completion of the polymerization of A-segment.

Thereto 5 mmol of BPhOVE and 5 mmol of IBVE were added as the B-segment component, and polymerization was continued. The molecular weight of the growing polymer was monitored at prescribed intervals by molecular sieve column chromatography (GPC) and NMR to detect the completion of the polymerization of B-segment and an AB di-block copolymer.

Further, a solution of 9 mmol of ethyl 4-(2-vinyloxy)ethoxybenzoate in toluene was added thereto and the polymerization was continued. After 24 hours, the polymerization was stopped by addition of an aqueous 0.3 mass % ammonia solution in methanol to the reaction system. The reaction mixture solution was diluted with dichloromethane. The diluted mixture was washed with a 0.6 mol/L hydrochloric acid solution three times, and then with distilled water three times. After the washing, the organic phase was evaporated to dryness by an evaporator, and was vacuum-dried. The dried residue was dialyzed repeatedly through a cellulose semipermeable membrane with a methanol solvent to remove monomeric compounds to obtain the intended tri-block copolymer. The copolymer was identified by NMR and GPC: Mn=24500, Mw/Mn=1.29, and polymerization ratio A:B:C=190:100:30. In the B-segment, the polymerization ratio of the two monomers was 1:1.

The above tri-block copolymer was treated with a mixture of dimethylfomamide and an aqueous sodium hydroxide solution to hydrolyze ethyl 4-(2-vinyloxy)ethoxybenzoate in the C-segment component. Thereby a sodium salt of the tri-block copolymer was obtained in which C-segment was a hydrophilic block segment having an anionic repeating unit structure. The copolymer was identified by NMR and GPC.

Further the copolymer was neutralized in an aqueous dispersion with 0.1N hydrochloric acid to obtain a tri-block copolymer having free carboxylic acid of 4-(2-vinyloxy)ethoxybenzoic acid in C-segment: namely, poly[MOVE-b-(IBVE-r-BPhOVE)-b-HBVE. The copolymer was identified by NMR and GPC.

### Example 2

A portion of 13 mass parts of the above tri-block copolymer, and 5 mass parts of a fat-soluble dye, Oil Blue-N (trade name, Aldrich Co.) were dissolved in dimethylformamide. Thereto 400 mass parts of distilled water was added to obtain an ink composition of an aqueous phase. Thereto 0.1 mL of an aqueous 0.1N sodium hydroxide solution was added, and homogenized with a supersonic wave homogenizer for 10 minutes. The mixture was left standing for one hour. The pH of the dispersion mixture was found to be 12 by a pH test paper. This dispersion mixture was highly transparent and had a blue color. Even after 10 days of standing, the fat-soluble dye causes neither separation nor precipitation.

The enclosure of the colorant and the hydrophobic polymer segment was confirmed by EF-TEM observation by cryotransfer, elemental analysis by EELS, and stimulation-responsiveness of the ABC block copolymer in the colorant dispersion mixture as described before.

The above ink composition was charged into a printing head of an inkjet printer (BJF800; Canon K.K.), and an image was formed by ejecting the ink composition onto a recording medium. The recording medium employed was a plain paper sheet on which a hydrochloric acid had been sprayed for causing stimulation. The recording medium and the dispersion composition were evaluated according to the methods (1) and (2) shown below.

(1) A solid square of 50 mm×50 mm was printed by the above printer. At 30 seconds after the printing, the printed portion was pressed strongly with a finger, but the ink did not adhere to the finger. This is considered to be due to increase of the fixation rate by viscosity increase by the tri-block copolymer in the composition, and to the scratch resistance improvement caused by enclosure of the colorant by the tri-block copolymer.

(2) A solid square of 50 mm×50 mm was printed with the above printer. At 30 seconds after the printing, the printed portion was rubbed strongly five times with a line marker, but no tailing of the blue color was observed. This is considered to be due to increase of the fixation rate by viscosity increase by the tri-block copolymer in the composition, and to the scratch resistance improvement caused by enclosure of the colorant by the tri-block copolymer.

### Comparative Example 1

A water-soluble dye ink was prepared by stirring 4 mass parts of a water-soluble dye, C.I.Direct Blue-199, and 17 mass parts of diethylene glycol in 79 mass parts of distilled water. The obtained ink was highly transparent and had a blue color. The recording mediums employed were the hydrochloric acid-sprayed plain paper sheet used in the above Example 2, and a non-sprayed plain paper sheet. The evaluation was conducted in the same manner as in Example 2.
(1) A solid square of 50 mm×50 mm was printed on paper sheets with the above printer. At 30 seconds after the printing, the printed portion on each of the recording sheets was pressed strongly with a finger. The ink came to adhere to the finger from the print on both of the hydrochloric acid-sprayed plain paper sheet and the non-sprayed recording paper sheet.
(2) A solid square of 50 mm×50 mm was printed with the above printer. At 30 seconds after the printing, the printed portion was rubbed strongly once with a line marker. Thereby the blue color print came to be blurred on both of the hydrochloric acid-sprayed recording paper sheet, and the non-sprayed recording paper sheet.

### Example 3

Synthesis of Tri-Block Copolymer Constituted of A-Segment: 2-Methoxyethyl Vinyl Ether (MOVE), B-Segment: Random Copolymer of Isobutyl Vinyl Ether and CH₂═CHOCH₂CH₂OPhPh (IBVE-r-VEEtPhPh), C-Segment: Methyl 4-(2-Vinyloxy)ethoxybenzenesulfonate

A glass container having a three-way stopcock was purged with nitrogen, and was heated in a nitrogen atmosphere to 250° C. to eliminate adsorbed water. The system was brought to room temperature. Thereto, were added 20 mmol of MOVE, 16 mmol of ethyl acetate, 0.1 mmol of 1-isobutoxyethyl acetate, and 11 mL of toluene. The reaction system was cooled to 0° C. Thereto 0.2 mmol of ethylaluminum sesquichloride (an equimolar mixture of diethylaluminum chloride and ethylaluminum dichloride) was added to initiate polymerization. The molecular weight of the growing polymer was monitored at prescribed time intervals by molecular sieve column chromatography (GPC) and NMR to detect the completion of the polymerization of A-segment.

Thereto a solution of 6 mmol of IBVE and 6 mmol of VEEtPhPh in toluene was added as the B-segment components, and polymerization was continued. The molecular weight of the growing polymer was monitored at prescribed time intervals by molecular sieve column chromatography (GPC) and NMR to detect the completion of the polymerization of B-segment. Then a solution of 12 mmol of C-segment component in toluene was added thereto and the polymerization was continued. After 24 hours, the polymerization was stopped by addition of an aqueous 0.3 mass % ammonia solution in methanol to the reaction system. The reaction mixture solution was diluted with dichloromethane. The diluted mixture was washed with a 0.6M hydrochloric acid solution three times, and then with distilled water three times. After the washing, the organic phase was evaporated to dryness by an evaporator, and was vacuum-dried. The dried residue was dialyzed repeatedly through a cellulose semipermeable membrane with a methanol solvent to remove monomeric compounds to obtain the intended tri-block copolymer. The copolymer was identified by NMR and GPC: Mn=33985, Mw/Mn=1.36, polymerization ratio A:B:C=200:100:30. In the B-segment, the polymerization ratio of the two monomers was 1:1.

The above tri-block copolymer was treated with a mixture of dimethylfomamide and an aqueous sodium hydroxide solution to hydrolyze the C-segment component. Thereby the tri-block copolymer was obtained in which C-segment component is hydrolyzed to a sodium salt. The copolymer was identified by NMR and GPC.

Further the copolymer was neutralized in an aqueous dispersion with 0.1N hydrochloric acid to obtain a tri-block copolymer having a free sulfonic acid group. The copolymer was identified by NMR and GPC.

### Example 4

A portion of 15 mass parts of the sulfonate salt type tri-block copolymer obtained in Example 3, and 7 mass parts of Oil Blue-N (C.I.Solvent Blue-14, Aldrich Co.) were dissolved in 150 mass parts of dimethylformamide. Thereto 400 mass parts of an aqueous NaOH solution was added to obtain an ink composition of an aqueous phase having pH 10. The mixture was left standing for 10 days. Even after 10 days of standing, the Oil Blue dye caused neither separation nor precipitation. The enclosure of the colorant and the hydrophobic polymer segment was confirmed by EF-TEM observation by cryotransfer, elemental analysis by EELS, and stimulation-responsiveness of the ABC block copolymer in the colorant dispersion mixture as described before.

The above ink composition was charged into a printing head of an inkjet printer (BJF800; Canon K.K.), and an image was formed by ejecting the ink composition onto a recording medium. The recording medium was a plain paper sheet on which a hydrochloric acid had been sprayed for causing stimulation to the ink. The recording medium and the dispersion composition were evaluated according to the methods (1) and (2) shown below.

(1) A solid square of 50 mm×50 mm was printed with the above printer. At 30 seconds after the printing, the printed portion was pressed strongly with a finger, but the ink did not come to adhere to the finger. This is considered to be due to increase of the fixation rate by viscosity increase by the tri-block copolymer in the composition, and to the scratch resistance improvement caused by enclosure of the colorant by the tri-block copolymer.

(2) A solid square of 50 mm×50 mm was printed with the above printer. At 30 seconds after the printing, the printed portion was rubbed strongly five times with a line marker, but no blurring of the blue color was observed. This is considered to be due to increase of the fixation rate by viscosity increase by the tri-block copolymer in the composition, and to the scratch resistance improvement caused by enclosure of the colorant by the tri-block copolymer.

### Comparative Example 2

An ink composition was prepared by mixing 2 mass parts of a self-dispersible black pigment, CAB-O-JET300 (trade name, Cabot Co.), 0.5 mass parts of a surfactant (Nonion E-230, Nihon Yushi K.K.), 5 mass parts of ethylene glycol, and 92.5 mass parts of deionized water.

The recording mediums used were the hydrochloric acid-sprayed plain paper sheet used in the above Example 2, and a non-sprayed plain paper sheet. The evaluation was conducted in the same manner as in Example 2.

(1) A solid square of 50 mm×50 mm was printed on paper sheets with the above printer. At 30 seconds after the printing, the printed portion on each of the recording sheets was pressed strongly with a finger. The ink came to adhere to the finger from the print on both of the hydrochloric acid-sprayed plain paper sheet and the non-sprayed recording paper sheet.

(2) A solid square of 50 mm×50 mm was printed with the above printer. At 30 seconds after the printing, the printed portion was rubbed strongly once with a line marker. Thereby blurring of the blue color was caused on both of the hydrochloric acid-sprayed recording paper sheet, and the non-sprayed recording paper sheet.

### Comparative Example 3

Synthesis of Poly(Hydroxystyrene-b-Styrene-b-Methacrylic Acid)

Into a system kept at a high vacuum at −78° C., was added a 10 mM nBuLi solution in 100 mL of THF and stirred. Then 0.15 mol of t-butoxystyrene was vaporized by heating and added into the cooled solvent to polymerize A-segment. After completion of the polymerization of the A-segment, a solution of 0.15 mol of styrene in 80 mL of THF was added thereto through a breakable seal placed in the system. After completion of polymerization of the B-segment, a solution of 0.1 mol of t-butyl methacrylate in 60 mL of THF was added thereto through a breakable seal. Finally, after completion of polymerization of C-segment, methanol was added thereto for quenching through a breakable seal to stop the reaction.

The reaction mixture was added to methanol to precipitate the formed polymer. The precipitate was collected by filtration with a glass filter. The collected precipitate was vacuum-dried. The precipitate was confirmed to be an intended tri-block copolymer by analysis by NMR and GPC: Mn=38200, Mw/Mn=1.33, Polymerization Ratio A:B:C=150:150:50.

The obtained block copolymer was hydrolyzed by hydrobromic acid to obtain a tri-block copolymer which has the A-segment component and the C-segment component both hydrolyzed. The copolymer was identified by NMR and GPC.

A portion of 15 mass parts of the obtained tri-block copolymer, and 7 mass parts of Oil Blue-N (C.I.Solvent Blue-14, Aldrich Co.) were dissolved in 150 mass parts of dimethylformamide. Thereto 400 mass parts of an aqueous NaOH solution was added to obtain an ink composition of an aqueous phase having pH 11.

Printing was conducted in the same manner as in Example 4. As the result, fuzziness of the print (non-printed region) was noticed. Deposit was found on the printer head. The deposit formation is considered to be caused by decomposition of the polymer in the high-temperature alkaline conditions.

### Comparative Example 4

A di-block copolymer of styrene and styrenesulfonic acid ester was synthesized in the same manner as in Comparative Example 2 (Mn=17600, Mw/Mn=1.33, Polymerization ratio=150:50). The di-block copolymer was hydrolyzed to obtain a hydrolyzed di-block copolymer in which the sulfonic acid ester group is hydrolyzed.

A portion of 15 mass parts of the obtained di-block copolymer, and 7 mass parts of Oil Blue-N (C.I.Solvent Blue-14, Aldrich Co.) were dissolved in 150 mass parts of dimethylformamide. Thereto 400 mass parts of an aqueous NaOH solution was added to obtain an ink composition of an aqueous phase having pH 10.

The recording mediums used were the hydrochloric acid-sprayed plain paper sheet used in the above Example 2, and a non-sprayed plain paper sheet. The evaluation was conducted in the same manner as in Example 2.

(1) A solid square of 50 mm×50 mm was printed on paper sheets with the above printer. At 30 seconds after the printing, the printed portion on each of the recording sheets was pressed strongly with a finger. The ink came to adhere to the finger from the print on both of the hydrochloric acid-sprayed plain paper sheet and the non-sprayed recording paper sheet.

(2) A solid square of 50 mm×50 mm was printed with the above printer. At 30 seconds after the printing, the printed portion was rubbed strongly once with a line marker. Thereby blurring of the blue color was caused on both of the hydrochloric acid-sprayed recording paper sheet and the non-sprayed recording paper sheet.

This application claims priority from Japanese Patent Application Nos. 2004-116802 filed Apr. 12, 2004 and 2004-139052 filed May 7, 2004, which are hereby incorporated by reference herein.

1. A block copolymer comprising three block segments of a first segment, a second segment, and a third segment, and containing a polyalkenyl ether main chain, wherein
the first segment is hydrophilic or hydrophobic,
the second segment is hydrophobic, and
the third segment is ionic; and
at least one of the block segments has a structure represented by General Formula (1) below:
—(CRaRb-CRc(OR¹))— (1)
wherein Ra, Rb, and Rc are respectively H or CH₃; R¹ is selected from the group consisting of linear, branched, or cyclic alkyl groups of 1 to 18 carbon atoms, —(CH(R²)—CH(R³)—O)ₗ—R⁴, and —(CH₂)ₘ—(O)ₙ—R⁴; l and m are an integer from 1 to 12; n is 0 or 1; R² and R³ are H or CH₃; R₄ is selected from the group consisting of H, linear, branched or cyclic alkyl groups of 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR⁵, -PhCOOR⁵, —CH₂SO₃R⁵, and -PhSO₃R⁵; the hydrogen on the carbon atoms constituting R⁴ except R⁵ moiety may be replaced by a linear or branched alkyl group of 1 to 4 carbon atoms, and the carbon in the aromatic ring may be replaced by nitrogen; and R⁵ is H, an alkyl group of 1 to 5 carbon atoms, or mono- or higher-valent cation.

2. The block copolymer according to claim 1, wherein the third segment has at least one residue derived from at least one chemical species selected from the group consisting of carboxylic acids, carboxylic acid salts, sulfonic acids, sulfonic acid salts.

3. A composition comprising a block copolymer set forth in claim 1, a functional substance, and a solvent.

4. The composition according to claim 3, wherein the solvent is an aqueous solvent.

5. The composition according to claim 3, wherein the functional substance is a colorant, and the composition is used as an ink.

6. The composition according to claim 5, wherein the solvent is an aqueous solvent.

7. The composition according to claim 5, wherein the composition is used as an ink for inkjet printing.

8. The composition according to claim 6, wherein the composition is used as an ink for inkjet printing.

9. A method for applying an ink comprising the steps of providing a composition set forth in claim 5, and applying the composition on a medium.

10. An ink applying apparatus, comprising an ink applying means for applying the composition set forth in claim 5 onto a medium by giving an energy to the composition, and a driving means for driving the ink applying means.
